(19) United States
(12) Patent Application Publication
(10) Pub. No.: US 2007/0171977 A1
(43) Pub. Date: Jul. 26, 2007

(54) Moving picture coding method and moving picture coding device

(76) Inventors: Shintaro Kudo, Kanagawa (JP); Kiyofumi Abe, Osaka (JP); Shinya Kadono, Hyogo (JP); Hiroaki Toida, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/656,957

(22) Filed: Jan. 24, 2007

(30) Foreign Application Priority Data
Jan. 25, 2006 (JP) 2006-015898

(51) Int. Cl. H04N 11/04; H04N 11/02

(52) U.S. Cl. 375/240.15; 375/240.16

(57) ABSTRACT

A moving picture is provided which can prevent image quality deterioration due to drops in motion vector prediction accuracy in temporal direct mode coding, and compress a moving image with great efficiency.

The moving picture coding device is a coding device which codes a moving picture that includes a B picture on which predictive coding is performed by referencing plural coded pictures which are temporally located before or after the B picture, and which includes a temporal direct mode processing unit operable to predict and generate a motion vector for a target block by referencing a motion vector of a coded picture that is temporally nearby, as a direct mode processing for the B picture, a temporal direct mode disabling assessment unit operable to assess whether use of the temporal direct mode should be disabled according to conditions for the moving picture to be coded; and, direct mode coding is performed on the moving picture to be coded using only the spatial direct mode processing unit, when use of the temporal direct mode is disabled by the temporal direct mode assessment unit.

### BACKGROUND OF THE INVENTION

(1) Field of the Invention

The present invention relates to a moving picture coding method and a moving picture coding device and particularly relates to technology that efficiently compresses a moving picture by preventing image deterioration caused by drops in motion vector prediction accuracy in direct mode.

(2) Description of the Related Art

In recent years, the world has transitioned to a multimedia era, in which audio, images and so on are handled in an integrated fashion, and means for communicating information such as newspapers, magazines, television, radio, telephones and other conventional information media have been made compatible with multimedia. Generally, multimedia means not just text, but also relates to graphics, audio and especially images and the like, and one precondition for integrating conventional information media into multimedia is expressing the information in a digital format.

However, when trying to estimate an amount of information held in each information medium above as an amount of digital information, the amount of information needed for audio is 64 Kbits (telephone quality) per second, and for video, 100 Mbits per second (current television reception quality) in contrast to the amount of information for text, which is 1 to 2 bytes per character, thus it is not realistic to handle such an enormous amount of information in a digital format for the information media above. For example, television telephones are already being implemented by using integrated service digital networks (ISDN) with communication speeds of 64 Kbit/s to 1 Mbits/s, however it is not possible to send television or camera moving pictures via ISDN.

Thus, what is needed is compression technology, such as video compression technology that uses the H.261 or H.263 specifications, as recommended by the ITU-T (International Telecommunications Union Electrical Communications Standardization section), which are used for video phones.

Here, Moving Picture Experts Group (MPEG) refers to an international motion picture signal compression standard that has been standardized by the International Standardization Institution and the International Electrotechnical Commission (ISO/IEC), and MPEG-1 refers to a standard for compressing moving picture signals to 1.5 Mbps i.e. compressing television signal information to 1/100^{th} of its size. Target quality for the MPEG-1 specification is a medium quality capable of realizing the moving image at 1.5 Mbps, and MPEG-2, which must meet demands for increases in quality, realizes a moving image signal in at TV broadcast quality from 2 to 15 Mbps. Further, in the present situation, a compression rate exceeding MPEG-1 and MPEG-2 has been achieved by working groups (ISO/IEC JTC1/SC29/WG11) who have advanced the standardization of MPEG-1 and MPEG-2 and has further made possible coding/decoding/handling on an object basis and MPEG-4, which realizes new and necessary functions for the multimedia age, has been standardized. Initially, MPEG-4 had pursued standardization of coding methods for low bit rates, but now generic coding is on the rise, which includes interlaced images with high bit rates.

Further, in 2003, MPEG-4 AVC and ITU H.264 were standardized as next-generation coding schemes which together have higher compression rates. In the H.264 standard, standards compatible with High Profile which have been applied to High Definition (HD) images have been established and are employed as compression standards for next generation media such as BD-ROM (Blu-ray Disk ROM).

Generally, in moving picture coding, the amount of information is compressed by reducing redundancies in the time direction and the spatial direction. Thus, in inter-picture predictive coding, which aims to reduce temporal redundancies, motion estimation is performed on a block-by-block basis by referencing a forward or a backward picture and a predictive image is created. A remainder between the obtained predictive picture and the picture to be coded is coded. Here, a picture stands for one picture, a progressive image stands for a frame, and an interlaced image stands for a frame or a field. Here, an interlaced image is an image composed of frames that include two fields with different times. When coding and decoding interlaced images, a single frame can be processed as a frame, as two fields, as a frame structure for every block in the frame or as a field structure.

A picture on which intra-picture predictive coding is performed without a reference picture is called an I picture. A picture which performs inter-picture predictive coding with only one reference picture is called a P picture. A picture which performs inter-picture predictive coding by referencing two pictures at the same time is called a B picture. A B picture can reference two pictures as an arbitrary combination of pictures with display times that are earlier than or later than the B picture. Reference images (reference pictures) can be designated as a basis for coding and decoding per block and are divided into first reference pictures, which are reference pictures that are described first in a coded bit stream, and second reference pictures, which are described after the first reference picture. Note that as a condition of coding and decoding P and B pictures, a reference picture must have already been coded and decoded.

Motion compensation inter-picture predictive coding is used to code P pictures and B pictures. Motion compensation inter-picture predictive coding is a coding method in which motion compensation is applied to inter-picture predictive coding. Motion compensation is a method for improving prediction accuracy and decreasing data loads not simply by performing prediction based on the pixel values of the reference frame, but instead by estimating an amount of motion (below, this is referred to as a motion vector) for each section in a picture and taking into account this amount of motion when performing prediction. For example, the amount of information is reduced by estimating a motion vector for the picture to be coded and by coding a prediction residual between a prediction value shifted by the amount of the motion vector, and the picture to be coded. Since the motion vector information is needed for decoding, the motion vector is also decoded and recorded or transmitted when using this method.

The motion vector is estimated on a macroblock-by-macroblock basis; specifically, the motion vector is estimated by fixing a macroblock on the side of the picture to be coded, shifting macroblocks on the reference picture side into the search area and finding the position of a reference block most similar to the base block.

When coding a B picture with the H.264 codec, a coding mode called direct mode can be selected. There are two types of methods in direct mode: a temporal method (temporal direct mode) and a spatial method (spatial direct mode). Direct mode can use only one of the temporal method and the spatial method for a slice (block sector) to be coded.

In temporal direct mode, the block to be coded does not itself have a motion vector; a motion vector used for the block to be coded is predicted and generated by performing a screening process based on the positional relationship in the sequence between pictures and which takes the motion vector of another coded picture as a reference motion vector.

FIG. 1 is a schematic diagram which shows the prediction generation method for a motion vector in the temporal direct mode. Note that the P shown in FIG. 1 stands for a P picture, the B stands for a B picture, and the number attached to the picture type indicates a place in the display order for each picture. Each picture P1, B2, B3 and P4 contains display order information T1, T2, T3 and T4 respectively. Below, a case is explained in which a block BL0 in the picture B3 shown in the FIG. 1 is coded using a temporal direct mode.

Utilized in this case is the motion vector MV1 for the block BL1, which is near the picture B3 in terms of display time, is included in the coded picture P4 and is at the same position as the block BL0. The motion vector MV1 is the motion vector utilized when the block BL1 is coded and the motion vector MV1 references the picture P1. In this case, the motion vectors used when the block BL0 is coded are a motion vector MV_F for the picture P1 and a motion vector MV_B for the picture P4. Here, when the size of the motion vector MV1 is MV, the size of the motion vector MV_F is MVf and the size of the motion vector MV_B is MVb; MVf and MVb may be obtained using the equations (1) and (2) respectively.

MVf=(T3−T1)/(T4−T1)×MV (1)

MVb=(T3−T4)/(T4−T1)×MV (2)

In this way, motion compensation is performed for the block BL0 using the motion vector MV_F which is obtained by performing a scaling process using the motion vector MV1 and the motion vector MV_B, and also for the picture P1 and the picture P4 which are reference pictures.

Note that when the block BL1, referenced for the scaling process, is a block on which intra-picture predictive coding is performed, and does not have a motion vector, motion compensation is performed assuming that the sizes of the motion vectors MV_F and MV_B are both “0”.

In spatial direct mode, as in temporal direct mode, the block to be coded itself does not have a motion vector; rather, a motion vector for a coded block positioned spatially near the block to be coded is referenced.

FIG. 2 is a schematic diagram which shows the prediction generation method for the motion vector in spatial direct mode. Note that the P shown in FIG. 2 stands for a P picture, the B stands for a B picture, and the number attached to each picture type stands for the location of each picture in a display order. Below, a case is explained in which a block BL0 in the picture B3 shown in the FIG. 2 is coded in spatial direct mode.

Among the motion vectors MVA1, MVB1 and MVC1 for a coded block which includes the three pixels A, B and C on the perimeter of the block BL0 to be coded, a motion vector referencing the closest coded picture to the picture to be coded, in terms of display time, is determined as a motion vector candidate for the block to be coded. When there are three motion vectors so determined, the median value for the three is selected as the motion vector for the block to be coded. When there are two motion vectors, the mean value of the three is found and becomes a motion vector for the block to be coded. When there is only one motion vector, the motion vector becomes the motion vector for the block to be coded.

In the example shown in FIG. 2, the motion vectors MVA1 and MVC1 are found by referencing the picture P2, and the motion vector MVB1 is found by referencing the picture P1. Thus a mean value for the motion vectors MVA1 and MVC1 which reference the coded picture P2, the picture P2 being closest in terms of display time to the picture to be coded, is found, and the average value is the first motion vector MV_F of the block to be coded. Finding the second motion vector MV_B involves the same process.

### [Non-Patent Reference 1]

ISO/IEC 14496-10, International Standard: “Information technology—Coding of audio-visual objects—Part 10: Advanced video coding” (2003-12-01).

Incidentally, most film media such as movies display at 24 frames per second (24 fps). When showing 24 fps material on a television, since a television displays at (NTSC) 29.97 fps, the display time interval between 24 fps and 29.97 fps must be converted. This conversion is known as a telecine conversion (2-3 conversion).

FIG. 3 is a figure which shows an conversion method for the telecine conversion.

In telecine conversion, as shown in FIG. 3, 24 fps is converted to 30 fps by converting the first frame of 24 fps to 2 fields, the next frame to 3 fields, and subsequently converting frames in sequence to 2 fields and 3 fields while assigning the converted fields to one frame for every two fields.

When performing a telecine conversion, since the 29.97 fps of NTSC deviates from 30 fps, a process for aligning the timing is performed at a fixed time interval by causing frame drop.

When the above conversion is performed, images with fields at different display times will be displayed, such as a field 1-0 in a 30P frame 1 and a field 1-0 in a 30P frame 2, as shown in FIG. 3. This means that the display time interval of the image on which a telecine conversion has been performed and the recorded time interval of the displayed image do not exactly match.

When coding a moving picture on which a telecine conversion has been performed using a temporal direct coding mode, a problem emerges in the scaling process for motion vector prediction.

That is to say, in temporal direct mode coding, a motion vector is predicted using the equation (1) and the equation (2) as described above. These equations are calculated based on display order information for the moving picture to be coded, and are not calculated based on the recorded time interval of the images displayed.

Thus, when the display order information and the recorded time interval do not match, there is no point in performing a scaling process for temporal direct mode motion vector prediction. An example of this is shown in FIG. 4.

FIG. 4 is a diagram which shows the coding in temporal direct mode for the image on which telecine transformation has been performed. Here, the abbreviations mean that I is coded as an I picture, P as a P picture and B as a B picture and the numerals indicate the place of the field in a display order. The field in parentheses indicates which field in FIG. 3 the field corresponds to.

In this case, for temporal direct mode coding in B4, the motion vector MV_P6 for the block BL3, which is at the same position as the block BL2 in the field P6 and is located in a coded picture near the field B4 in terms of display time, uses the display order information Tb6, Tp2 and Ti0 for the field IO, which is referenced by the field B4, the field P6 and BL3, to predict a motion vector in the equations below.

MVf_{—}b6=(Tb6−Ti0)/(Tp2−Ti0)×MV_{—}P2 (3)

MVb_{—}b6=(Tb6−Tp2)/(Tp2−Ti0)×MV_{—}P2 (4)

Below, the field display order information interval is referred to as Ta, and the above equations (3), (4) are expressed by the equations (5) and (6) below.

MVf_{—}b6=(4×Ta/6×Ta)×MV_{—}P2=(⅔)×MV_{—}P2 (5)

MVb_{—}b6=(−2×Ta/6×Ta)×MV_{—}P2=−(⅓)×MV_{—}P2 (6)

Since the results of MVf_b6 and MVb_b6 above are achieved using display information that deviates from the time at which the picture is recorded, an inaccurate scaling will be performed. For example, when objects in a picture are shifted by a fixed interval as in FIG. 5, since the recorded times for field IO, the field B4 and the field P6 are fixed, when the object shift distance for the field P6 relative to the field IO is L, the shift distance within the field B4 becomes L/2. When a scaling process is performed as above based on the recorded time, the motion vectors to be predicted are expressed by the equations (7) and (8) below, since the intervals between Ti0, Tb6 and Tp2 are fixed.

MVf_{—}b6=(½)×MV_{—}P2 (7)

MVb_{—}b6=−(½)×MV_{—}P2 (8)

This matches the scaling of the shift distance in the example in FIG. 5. Generally, since the background and objects are often moving at a fixed speed in a moving picture, a motion vector can be predicted with high accuracy when predicted based on the recorded time.

However, when temporal direct mode motion vector prediction is performed for a moving picture on which a telecine conversion has been performed, as above, an inaccurate scaling will be performed since the motion vector is predicted using display order information which deviates from the recorded time intervals. As a result, the image quality will deteriorate.

When using the temporal direct mode on the moving picture, in which the display order information and the recorded time interval deviate from each other, and on which a display time interval conversion such as a telecine conversion has been performed, there is the problem that the image quality will deteriorate.

Also, when the coded picture which is used as a reference for the motion vector and is located near the picture to be coded in terms of display time is an I picture, the picture to be coded is temporal direct mode coded in the same way as the block BL1 above is intra-picture coded. In other words, for all of the blocks in a picture to be coded, there is the problem that the motion vector is not predicted in the (spatial) direct mode, that prediction accuracy worsens and the image quality deteriorates.

### SUMMARY OF THE INVENTION

Therefore, the present invention has as an object providing a moving picture coding method and a moving picture coding device capable of preventing image quality deterioration caused by drops in prediction accuracy for a motion vector in temporal direct mode coding, and efficiently compressing a moving picture.

In order to resolve the problems above, the moving picture coding method according to the present invention is a moving picture coding method which codes a moving picture that includes a B picture on which predictive coding is performed by referencing plural coded pictures temporally located before or after the B picture, the moving picture method including predicting and generating a motion vector for a target block by referencing a motion vector of a coded picture that is temporally nearby, as a direct mode processing for the B picture; and assessing whether use of the temporal direct mode should be disabled according to a condition for the moving picture to be coded, and, in said assessing, predictive coding is performed on the moving picture to be coded using a process other than said predicting and generating, when use of the temporal direct mode is disabled.

Thus, in the case where it is predicted that image quality deterioration will occur when temporal direct coding is used, image quality deterioration due to drops in motion vector prediction accuracy for temporal direct mode coding can be prevented by not activating temporal direct mode, and it is possible to compress the moving picture with great efficiency.

Furthermore, in the moving picture coding method according to the present invention, referencing a motion vector of a coded block located in a spatial periphery of the target block and predicting and generating a motion vector for the target block as a direct mode for the B picture is included in the process other than said predicting and generating; and in said assessing, the predictive coding is performed on the moving picture to be coded using said predicting and generating when use of the temporal direct mode is disabled.

Thus, it is possible to compress the moving picture with great efficiency since image quality deterioration due to drops in motion vector prediction accuracy for temporal direct mode coding can be prevented.

Furthermore, the moving picture coding method according to the present invention is characterized in that, in said assessing, it is assessed that use of the temporal direct mode should be disabled when it is assessed that the time intervals of pictures which compose the moving picture to be coded are not fixed.

Thus, it becomes possible to prevent deterioration in image quality due to drops in motion vector prediction accuracy for temporal direct mode coding, which occur when the time intervals recorded for the pictures that are recorded as images are not fixed.

Furthermore, the moving picture coding method according to the present invention is characterized in that, in said assessing, it is assessed that use of the temporal direct mode should be disabled when it is assessed that a picture-display time interval conversion has been performed on the moving picture to be coded.

Thus, there are cases where the time intervals for the pictures which compose the moving picture on which a picture-display time interval conversion has been performed are not fixed, and it becomes possible to prevent deterioration in image quality due to drops in motion vector prediction accuracy for temporal direct mode coding in such cases.

Furthermore, the moving picture coding method according to the present invention is characterized in that, in said assessing, it is assessed that use of the temporal direct mode should be disabled when it is assessed that the coded picture used as a reference for the motion vector in the temporal direct mode is an I picture on which intra-picture predictive coding is to be performed.

Thus, it becomes possible to prevent deterioration in image quality due to drops in motion vector prediction accuracy in temporal direct mode coding, which occur when an I picture is referenced.

Furthermore, the moving picture coding method according to the present invention is characterized in that, in said assessing, it is assessed whether or not one of at least two of the following cases applies: when it is assessed that the time intervals for the pictures which compose the moving picture to be coded are not fixed; when it is assessed that a picture-display time interval conversion has been performed on the moving picture to be coded; and when it is assessed that the coded picture that is used as a reference for the motion vector in the temporal direct mode is an I picture on which intra-picture predictive coding is performed, and in the case where one of at least two of the cases applies, it is assessed that use of the temporal direct mode should be disabled.

Thus, it becomes possible to further prevent deterioration in image quality since drops in motion vector prediction accuracy in temporal direct mode coding can be reliably prevented.

Note that the present invention can also be embodied as a moving picture coding method having, as steps, the characteristic constituent elements included in the moving picture coding device of the present invention, and as a program that causes a computer to execute the steps. The program can be distributed on a recording medium such as a CD-ROM, and via a transmission medium such as a communication network.

As is clear from the explanations above, according to the moving picture coding method in the present invention, image quality deterioration due to drops in accuracy for motion vector prediction using temporal direct mode coding can be prevented and it is possible to compress the moving picture highly effectively.

Thus, according to the present invention, it is possible to distribute a moving picture with a high compression rate and a high image quality and now that the internet has become widespread, the practical value of the present invention is extremely high.

### FURTHER INFORMATION ABOUT TECHNICAL BACKGROUND TO THIS APPLICATION

The disclosure of Japanese Patent Application No. 2006-015898 filed on Jan. 25, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a schematic diagram which shows the prediction generation method for the motion vector in temporal direct mode;

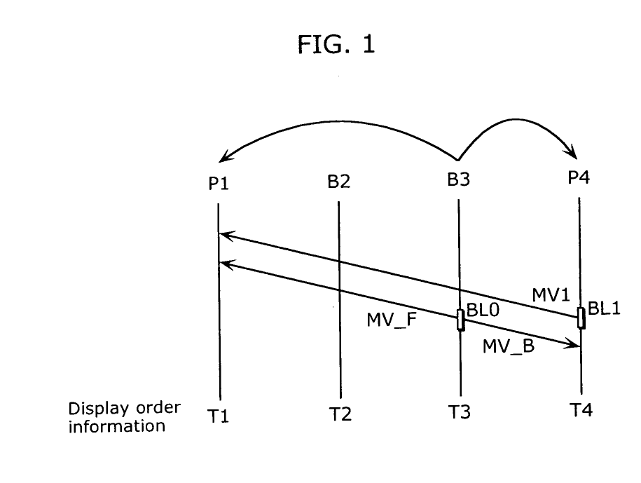

FIG. 2 is a schematic diagram which shows the prediction generation method for the motion vector in spatial direct mode;

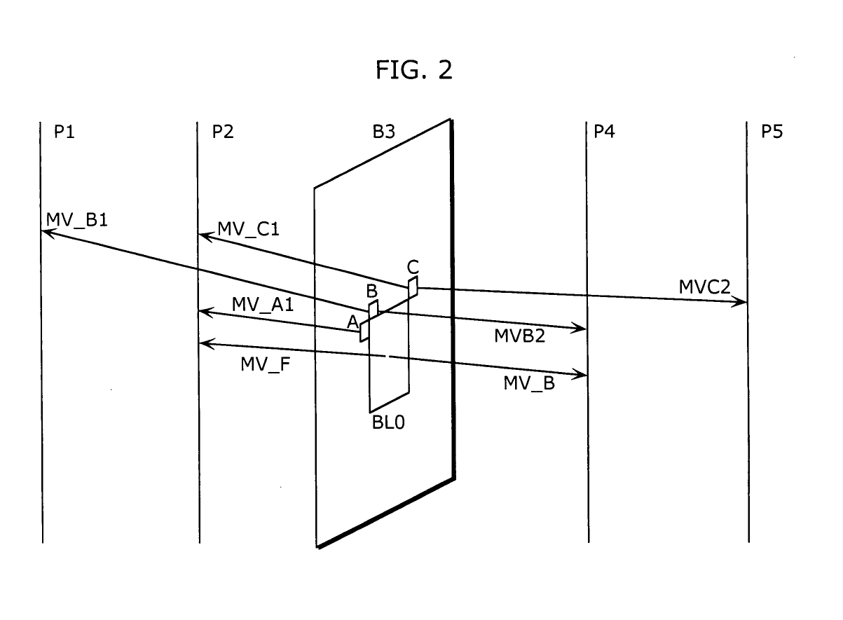

FIG. 3 is a diagram which shows an example of a telecine conversion (2-3 conversion);

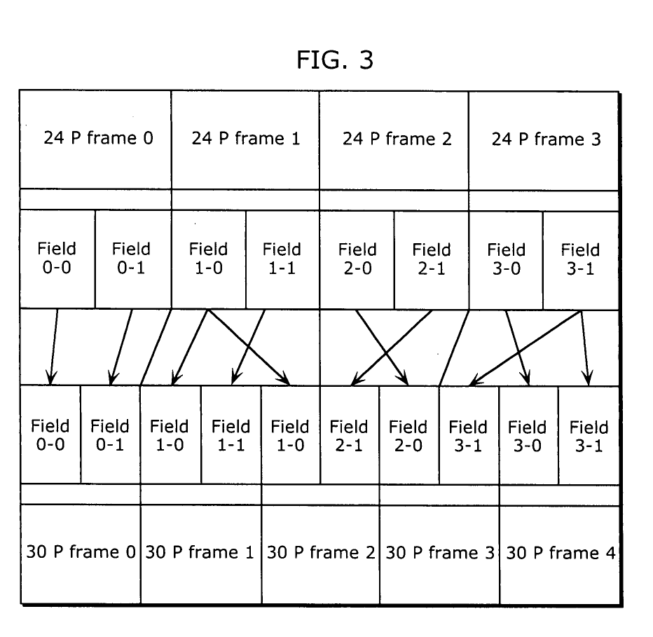

FIG. 4 is a diagram which shows an example of temporal direct mode motion vector prediction for the moving picture on which the telecine conversion (2-3 conversion) has been performed;

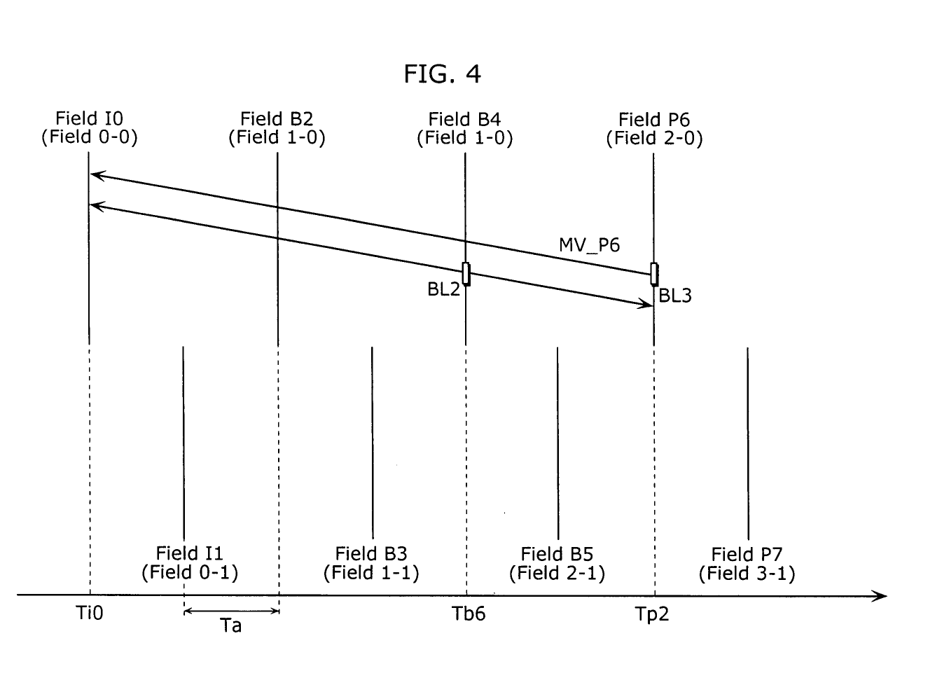

FIG. 5 is a diagram which shows an example of temporal direct mode motion vector prediction for the moving picture on which the telecine conversion (2-3 conversion) has been performed;

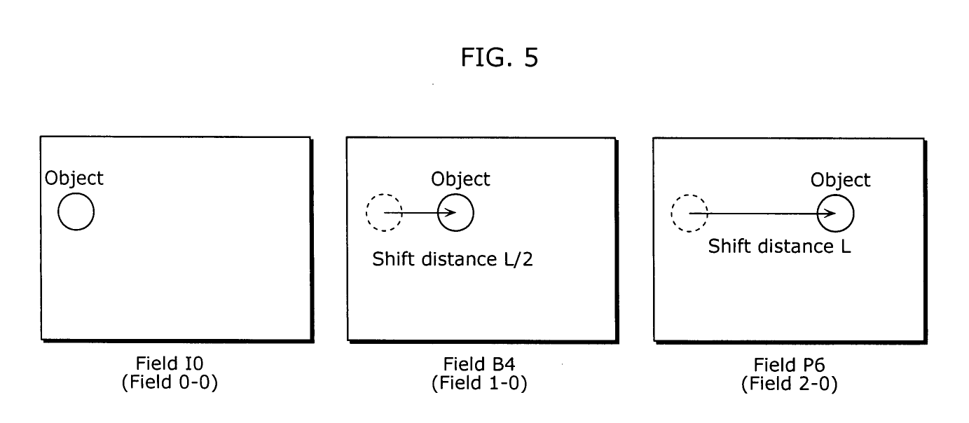

FIG. 6 is a block diagram which shows the structure of the moving picture coding device according to the first embodiment of the present invention;

FIG. 7 is a diagram which shows diagram (a) in which a sequence of the pictures is shown and a diagram (b) which shows the inputted sequence re-arranged into a new sequence;

FIG. 8 is a flowchart which shows an operation for determining whether temporal direct mode is used or not by the method 1 in a temporal direct mode disabling assessment unit;

FIG. 9 is a block diagram which shows the structure of the moving picture coding device according to the second embodiment of the present invention;

FIG. 10 is a flowchart which shows an operation for determining whether temporal direct mode is used or not by a method 2 in the temporal direct mode disabling assessment unit;

FIG. 11 is a block diagram which shows the structure of the moving picture coding device according to the third embodiment of the present invention;

FIG. 12 is a flowchart which shows an operation for determining whether temporal direct mode is used or not by a method 3 in the temporal direct mode disabling assessment unit;

FIG. 13 is a block diagram which shows the structure of the moving picture coding device according to the fourth embodiment of the present invention;

FIG. 14 is a flowchart which shows an operation for determining whether temporal direct mode is used or not by a combination of the method 2 and the method 3 in the temporal direct mode disabling assessment unit; and

FIG. 15 is an explanatory diagram of a recording medium that stores a program for realizing the moving picture coding method according to the first to fourth embodiments via a computer system.

### DESCRIPTION OF THE PREFERRED EMBODIMENT(S)

Below, an embodiment of the present invention is described with reference to figures.

### First Embodiment

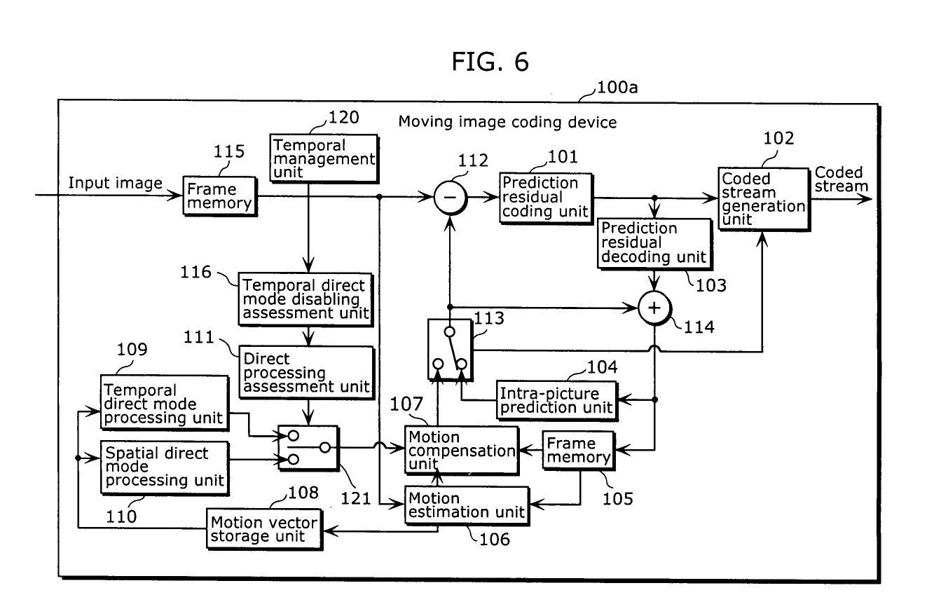

FIG. 6 is a block diagram of the moving picture coding device 100a according to the first embodiment of the present invention.

The moving picture coding device 100a is a device for compression coding an image inputted from an AV device and the like, and includes a prediction residual coding unit 101, a code stream generation unit 102, a prediction residual decoding unit 103, an intra-picture prediction unit 104, a frame memory 105, a motion estimation unit 106, a motion compensation unit 107, a motion vector storage unit 108, a temporal direct mode processing unit 109, a spatial direct mode processing unit 110, a direct processing assessment unit 111, a subtraction unit 112, a mode selection unit 113, an addition unit 114, a frame memory 115, a temporal direct mode disabling assessment unit 116, and a mode selection unit 121, as shown in FIG. 6.

The motion estimation unit 106 uses coded restructured image data as a reference picture and estimates a motion vector which shows a position predicted to be the most accurate within the search area of the picture.

The motion compensation unit 107 determines a coding mode for inter-picture coding by using the motion vector estimated by the motion estimation unit 106 and generates prediction image data based on the coding mode. The coding mode indicates what kind of method is used to code the macroblock.

The motion vector storage unit 108 stores the motion vector estimated by the motion estimation unit 106.

The temporal direct mode disabling assessment unit 116 assesses whether temporal direct mode can be used based on information in the moving picture to be coded, i.e. whether temporal direct mode has been disabled, and notifies the assessment result to the direct processing assessment unit 111.

The direct processing assessment unit 111 assesses whether predictive coding is performed on the image to be coded in temporal direct mode used as a direct coding mode, or whether a mode other than the temporal direct mode is used, based on the notification by the temporal direct mode disabling assessment unit 116.

The temporal direct mode processing unit 109 predicts the motion vector by referencing a motion vector for a block in the coded image at the same position as the block to be coded and performing a scaling process, when the direct coding mode is temporal direct mode, the coded image being located near the image to be coded in terms of display time, and the image to be coded being stored in the motion vector storage unit 108.

When the direct coding mode is spatial direct mode, the spatial direct mode processing unit 110 predicts the motion vector by referencing the motion vector for an adjacent block that has been coded and which is stored in the motion vector storage unit 108.

The mode selection unit 121 outputs one of: the motion vector prediction performed by the temporal direct mode processing unit 109 and the motion vector prediction performed by the spatial direct mode processing unit 110, based on the assessment result of the temporal direct mode processing unit 109, to the motion compensation unit 107.

The intra-picture prediction unit 104 generates prediction image data using adjacent pixels to the block to be coded as an intra-picture coding mode.

The mode selection unit 113 selects the mode with the better coding efficiency between the inter-picture predictive coding mode, as determined by the motion compensation unit 107, and the coding mode of the intra-picture prediction unit 104.

The subtraction unit 112 generates prediction residual image data by calculating the difference between the image data read out of the frame memory 115 and the prediction image data in the motion compensation unit 107 or the intra-picture prediction unit 104.

The prediction residual coding unit 101 generates coded data by performing a coding process such as frequency conversion or quantization on the prediction residual image data that is inputted.

The code column generation unit 102 generates a coded stream by performing variable-length coding and the like on the inputted coded data, and further by adding coding mode information and so on inputted by the mode selection unit 113.

The prediction residual decoding unit 103 generates decoded data by performing a decoding process such as reverse quantization and reverse frequency conversion on the inputted coded data.

The addition unit 114 adds the decoded residual image data inputted from the prediction residual decoding unit 103 to the prediction image data in the mode selected by the mode selection unit 113 and generates reconstructed image data.

The frame memory 105 stores the reconstructed image data generated by the addition unit 114.

Next, the processes of the moving picture coding device configured as above are explained.

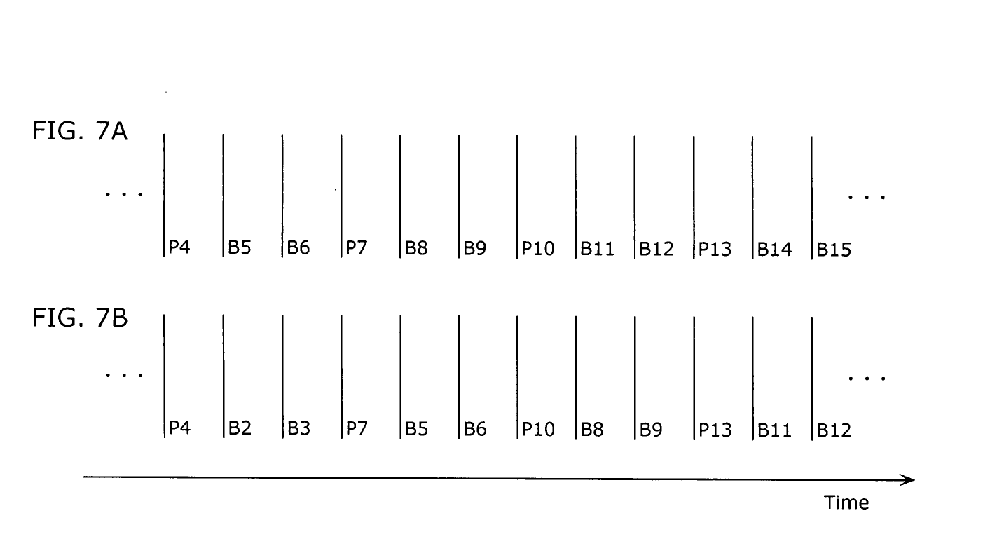

FIG. 7 is an explanatory diagram which shows a picture sequence stored in the frame memory 115, and more specifically, FIG. 7(a) shows the inputted sequence and FIG. 7(b) shows the re-arranged sequence. Here, vertical lines stand for pictures and in the symbols shown at the bottom right of each picture, the first letter indicates the picture type (I, P, B) while the numbers following the letter indicate the picture number. A P picture uses a nearby I picture or P picture which appears ahead in the display order as a reference picture, and a B picture uses, as reference pictures, an I picture, a P picture, and a B picture that can be referenced which appear ahead in the display order, as well as one nearby I picture or P picture which appears after in the display order.

For example, the input image is inputted into the frame memory 115 on a picture-by-picture basis in the display order shown in FIG. 7(a). When the picture type to be coded is determined, each picture inputted into the frame memory 115 is re-arranged into an order in which coding is performed, as shown in FIG. 7(b). The coding order is re-arranged based on the reference relationships in inter-picture predictive coding, and so that a picture used as the reference picture is coded first.

Each picture that is re-arranged in the frame memory 115 is, for example, split into 16 horizontal by 16 vertical pixel groups, and read out on a macroblock-by-macroblock basis. Motion compensation and motion estimation is performed on a block-by-block basis, the blocks being split into groups of, for example, 16 horizontal by 16 vertical pixels, 8 horizontal by 16 vertical pixels, 16 horizontal by 8 vertical pixels and 8 horizontal by 8 vertical pixels.

The subsequent operations are explained for when the picture to be coded is a B picture.

Inter-picture predictive coding is performed for B pictures using two-way referencing. For example, in the example shown in FIG. 7(a), when the coding process for the picture B11 is performed, the reference pictures appearing ahead in the display order are pictures P10, P7 and P4, and the reference picture which appears after in the display order is the picture P13. Here, a case is considered wherein the B picture is not used as a reference picture during the coding of another picture.

A macroblock in the picture B11 that is read out of the frame memory 115 is inputted into the motion estimation unit 106 and the subtraction unit 112. The motion estimation unit 106 uses the reference picture stored in the frame memory 105 to estimate a forward motion vector and a backward motion vector for each block in the macroblock. Here, reconstructed image data for the pictures P10, P7 and P4 stored in the frame memory 105 are used as a forward reference picture, and reconstructed image data for the picture P13 is used as a backward reference picture. The motion estimation unit 106 outputs the estimated motion vector to the motion compensation unit 107.

The motion compensation unit 107 determines a coding mode for inter-picture prediction for macroblocks by using the motion vector estimated by the motion estimation unit 106. Here, the inter-picture coding mode for the B picture can be selected from among inter-picture predictive coding using the forward motion vector, inter-picture predictive coding using the backward motion vector, inter-picture predictive coding using a bi-directional motion vector and direct mode. The direct process assessment unit 111 determines, on a specified basis, which direct mode to use: temporal direct mode or spatial direct mode. In determining the coding mode, a method is selected which generally has a low coding load and in which coding errors decrease. Note that the specific basis above may be any one of bases larger than a slice such as a slice-by-slice basis, a picture-by-picture basis, a GOP-by-GOP basis and a sequence-by-sequence basis.

The mode selection unit 113 takes the inter-picture predictive coding mode determined by the motion compensation unit 107 and the intra-picture predictive coding mode determined by the intra-picture prediction unit 104 as inputs, selects the mode which has a generally low coding load and further which has the highest coding efficiency, and the selected mode becomes the coding mode for macroblocks.

Next, the processes of the temporal direct mode disabling assessment unit 116 are explained. The operations for temporal direct mode disabling assessment can be performed using a method 1 explained below.

(Method 1)

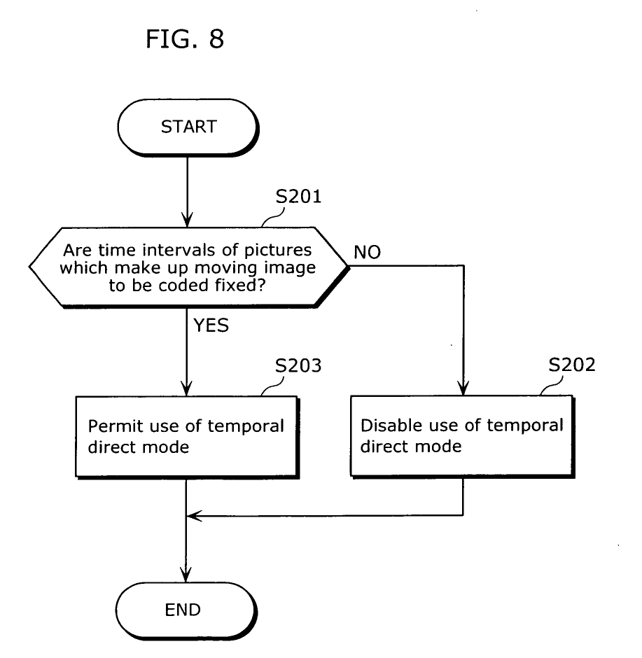

FIG. 8 is a flowchart which shows temporal direct mode disabling assessment operations according to the method 1.

The temporal direct mode disabling assessment unit 116 performs assessment based on the information about the moving picture to be coded. First, the temporal direct mode disabling assessment unit 116 assesses whether or not the time intervals for the pictures which compose the moving picture to be coded are fixed. When the time intervals for the pictures are not fixed (NO in Step S201), the temporal direct mode disabling assessment unit 116 disables the use of temporal direct mode (Step S202). Here, when the time intervals are not fixed, for example when frame drop has occurred, temporal direct mode is disabled. On the other hand, when the time intervals for the pictures are fixed (YES in Step S201), the temporal direct mode disabling assessment unit 116 permits the use of temporal direct mode (Step S203). Subsequently, the temporal direct mode disabling assessment unit 116 notifies the direct processing assessment unit 111 of whether or not temporal direct mode is used.

Note that the assessment in the above Step S201 may be performed using time information for each picture provided to the coding device, or the assessment may be performed using information as to whether or not the time intervals provided to the coding device are fixed, or the assessment may be performed using the time interval information obtained by distinguishing whether or not coding has actually been performed for every picture inputted into the coding device or whether the coding has been skipped. In other words, the information may be from outside or may be information obtained by the internal time management unit 120.

Note that the temporal direct mode disabling assessment process according to the present embodiment may be performed on a picture-by-picture basis, a GOP-by-GOP basis in which plural pictures have been grouped into one picture, a sequence-by-sequence basis divided up by specific pictures, or on a stream-by-stream basis which is the entire moving picture stream to be coded. In other words, a range for which temporal direct mode is disabled may be the smallest range between the reference picture and the picture to be coded when frame drop has occurred, or may be on a wide-ranged basis when frame drop has occurred on a time scale that exceeds the minimal range.

By using the method 1 above, and by the scaling process in motion vector prediction for temporal direct mode coding, the moving picture coding device does not have to calculate motion vectors with a low prediction accuracy, and deterioration of image quality can be prevented.

### Second Embodiment

Next, another embodiment of the present invention is explained.

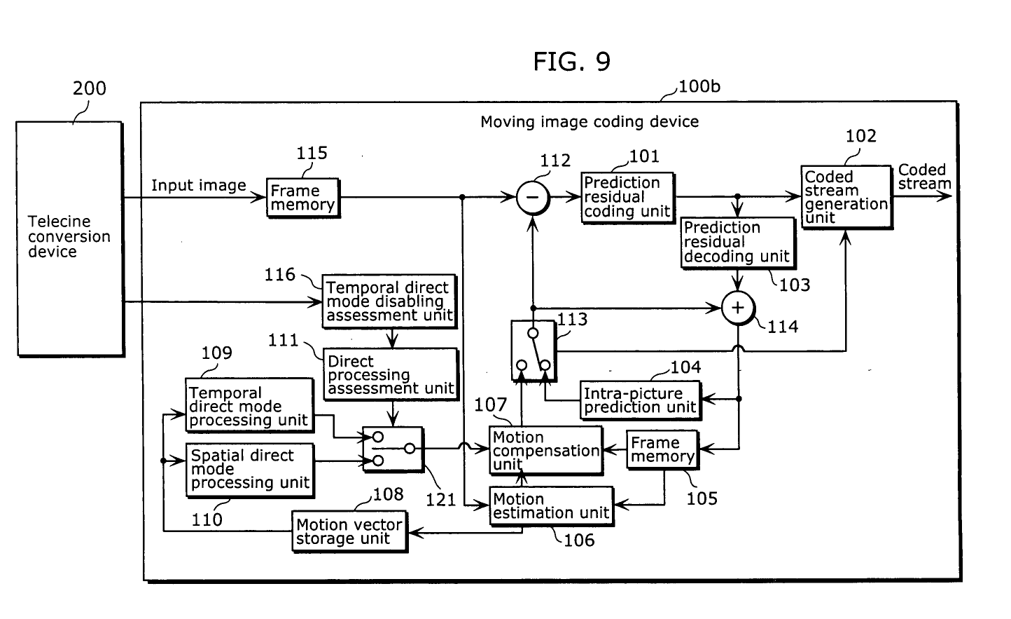

FIG. 9 is a block diagram which shows a functional configuration of a moving picture coding device 100b according to the second embodiment of the present invention. Note that the moving picture coding device 100b is displayed together with the telecine conversion device 200 in the diagram. Note also that the same numbers are attached to units of the moving picture coding device 100b which correspond to the structure of the moving picture coding device 100a as shown in FIG. 6; the explanation for these units is not repeated and a detailed explanation is provided for differing units.

Here, the moving picture coding device 100b differs from the moving picture coding device 100a shown in FIG. 6 in that the temporal direct mode disabling assessment unit 116 is structured to assess whether or not the object to be coded is a moving picture on which the display time interval conversion has been performed, based on information about the moving picture received from the telecine conversion device 200 and so on.

Next, the processes of the moving picture coding device 100b configured as above are explained.

(Method 2)

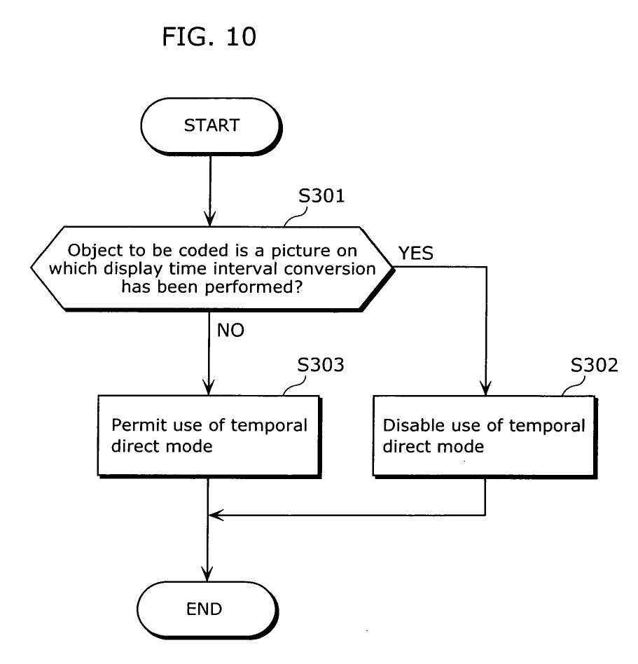

FIG. 10 is a flowchart which shows temporal direct mode disabling assessment operations using a method 2.

The temporal direct mode disabling assessment unit 116 performs assessment based on information about the moving picture to be coded. First, the temporal direct mode disabling assessment unit 116 assesses whether or not the moving picture to be coded is a moving picture on which a conversion of the display time interval has been performed. When the object to be coded is a moving picture on which the conversion has been performed (YES in Step S301), the temporal direct mode disabling assessment unit 116 disables the use of temporal direct mode (Step S302). On the other hand, when the object to be coded is a moving picture on which the conversion has not been performed (NO in Step S301), the temporal direct mode disabling assessment unit 116 permits the use of temporal direct mode (Step S303). Subsequently, the temporal direct mode disabling assessment unit 116 notifies the direct processing assessment unit 111 of whether or not temporal direct mode is used.

Note that the conversion of the picture display time interval is used for the assessment, however the conversion of the display time interval may be limited to a telecine conversion (2-3 conversion).

In addition, information which shows whether or not the picture display time interval conversion utilized in the above Step S301 may be provided by the telecine conversion device 200, which is external to the coding device, and the information may determine whether or not the picture display time conversion has been performed, using the characteristics of the image inside the moving picture coding device 100a.

Ordinarily, when a telecine conversion (2-3 conversion) has been performed, temporal direct mode may be disabled for the entire range on which the telecine conversion is performed, however there are cases where the time interval relationships between the pre-conversion and post-conversion display time intervals are equal depending on the position relationships between the picture to be coded and the picture whose motion vector is referenced in temporal direct mode. In other words, there are cases where there are no obstructions to scaling for the time interval. When these kinds of conditions are estimated in a case corresponding to the above conditions, an assessment process may permit the conventional use of temporal direct mode.

Using the method 2 above and the scaling process in motion vector prediction for temporal direct mode coding, the moving picture coding device no longer needs to calculate motion vectors with low prediction accuracy, and the deterioration of image quality can be prevented.

### Third Embodiment

Next, another embodiment of the present invention is explained.

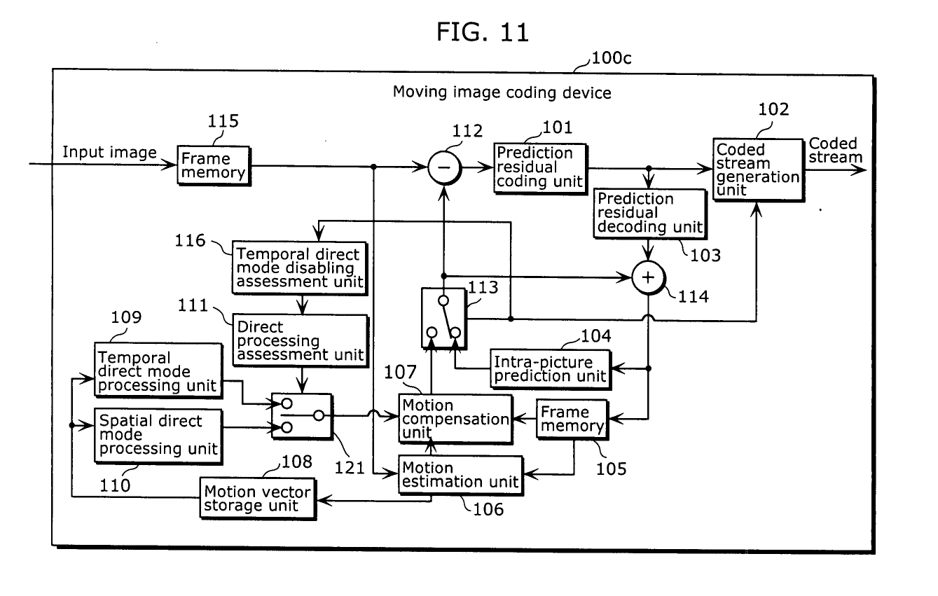

FIG. 11 is a block diagram which shows a functional structure of the moving picture coding device 100c in the third embodiment of the present invention. Note also that the same numbers are attached to units of the moving picture coding device 100c which correspond to the structures of the moving picture coding devices 100a and 100b shown in FIGS. 6 and 9 respectively; the explanation for these units is not repeated and a detailed explanation is provided for differing units.

Here, the moving picture coding device 100c differs from the moving picture coding devices 100a and 100b shown in FIGS. 6 and 9 in that the moving picture coding device 100c is structured so that the temporal direct mode disabling assessment unit 116 assesses whether or not a coded picture used as a motion vector reference in temporal direct mode is an I picture.

Next, processes of the moving picture coding device 100c configured as above are explained.

(Method 3)

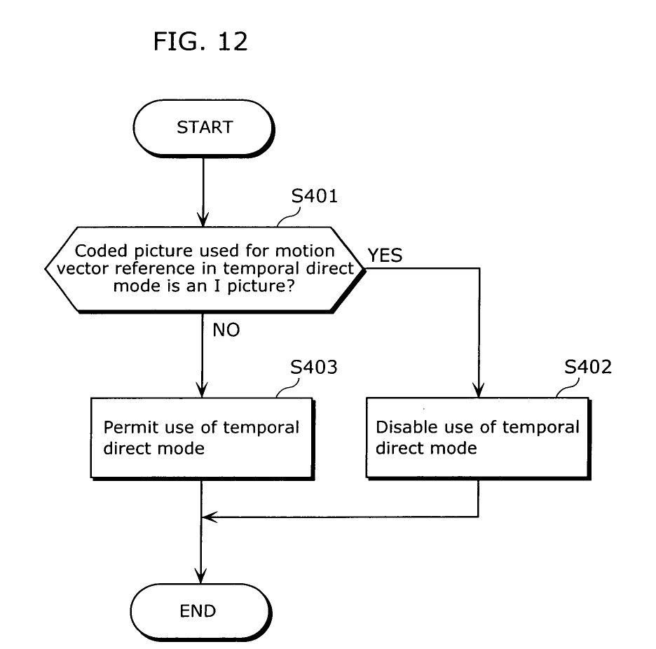

FIG. 12 is a flowchart which shows temporal direct mode disabling assessment operations using a method 3.

The temporal direct mode disabling assessment unit 116 performs assessment based on information about the moving picture to be coded. First, the temporal direct mode disabling assessment unit 116 determines whether or not the coded picture used as a motion vector reference in temporal direct mode is an I picture (Step S401). This assessment is performed for example according to the type of reference picture sent from the mode selection unit 113. When the type of picture is an I picture (YES in Step S401), the temporal direct mode disabling assessment unit 116 disables use of temporal direct mode (Step S402).

On the other hand, when the type of picture is an I picture (NO in Step S401), the temporal direct mode disabling assessment unit 116 permits the use of temporal direct mode (Step S403). Subsequently, the temporal direct mode disabling assessment unit 116 notifies the direct processing assessment unit 111 of whether or not temporal direct mode is used.

Using the method 3 above and the scaling process in motion vector prediction for temporal direct mode coding, the moving picture coding device no longer needs to calculate motion vectors with low prediction accuracy, and the deterioration of image quality can be prevented.

### Fourth Embodiment

Methods 1 through 3 are explained as separate methods for each of the first through third embodiments, however a combination of at least two of these methods may be combined and embodied. As an example of this, a case in which the method 2 and the method 3 are combined is explained below.

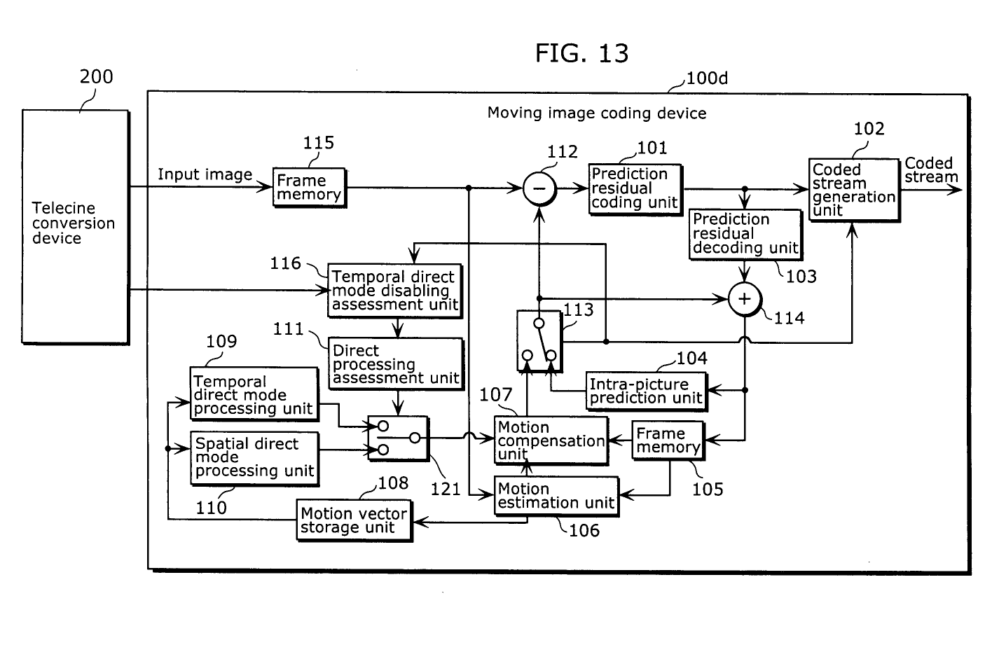

FIG. 13 is a block diagram of the moving picture coding device 100d according to the fourth embodiment of the present invention. Note also that the same numbers that correspond to the structures of the moving picture coding devices 100a, 100b and 100c as shown in FIGS. 6, 9 and 11 respectively are attached to units of the moving picture coding device 100d; the explanation for these units is not repeated and a detailed explanation is provided for differing units.

Here, the moving picture coding device 100d differs from the structures of the moving picture coding device 100a, 100b and 100c as shown in FIGS. 6, 9 and 11 in that the moving picture coding device 100d is structured so that the above method 2 and the method 3 are combined and executed.

Next, a process for the moving picture coding device 100d configured as above is explained.

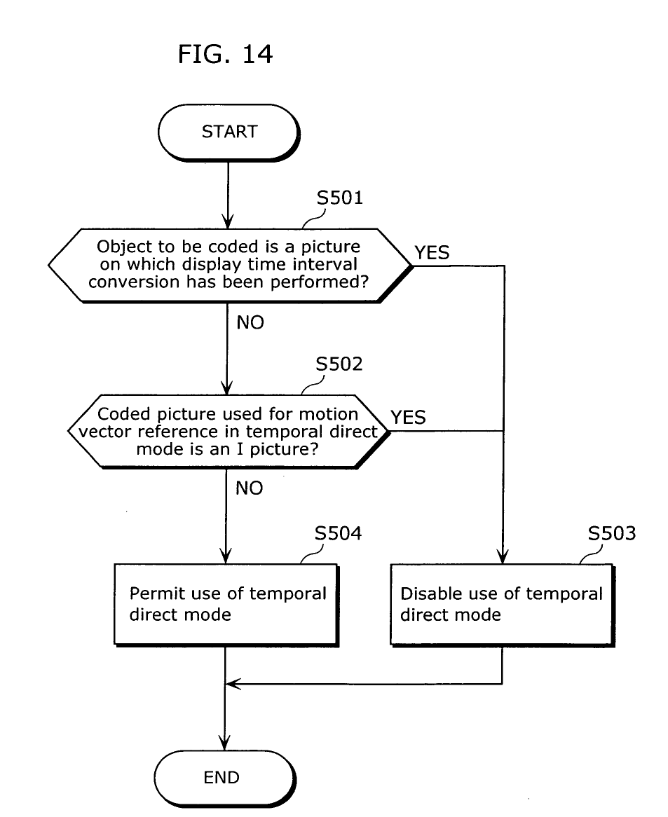

FIG. 14 is a flowchart which shows a case where the method 2 and the method 3 are combined.

First, the temporal direct mode disabling assessment unit 116 assesses whether or not the moving picture to be coded is a moving picture on which a conversion of the display time interval has been performed (Step S501). When the object to be coded is a moving picture on which the conversion has been performed (YES in Step S501), the temporal direct mode disabling assessment unit 116 disables the use of temporal direct mode (Step S503). On the other hand, when the conversion has not been performed (NO in Step S501), the temporal direct mode disabling assessment unit 116 determines whether or not the coded picture used as a motion vector reference in temporal direct mode is an I picture (Step S502). When the motion vector reference is an I picture (YES in Step S502), the temporal direct mode disabling assessment unit 116 disables the use of temporal direct mode (Step S503).

On the other hand, when the motion vector reference is not an I picture (NO in Step S502), the temporal direct mode disabling assessment unit 116 permits the use of temporal direct mode (Step S504).

Subsequently, the temporal direct mode disabling assessment unit 116 notifies the direct processing assessment unit 111 of whether or not temporal direct mode is used.

With such a method, combining the method 1, 2 and 3, the method 1 and 2, and the method 1 and 3, the frequency of motion vector calculation with low prediction accuracy can be reduced further, and deterioration in image quality can be prevented by performing a scaling process for the motion vector prediction in temporal direct mode coding. Here, for instance in FIG. 14, the process is performed in the order Step S501, S502, however the process may be performed with the order reversed and the order of the processes is not limited for any other combination.

### Fifth Embodiment

Further, the processes indicated in each embodiment above one through four can be easily implemented in an independent computer system by recording a program for implementing the moving picture coding methods shown in each embodiment above onto a recording medium such as a flexible disc.

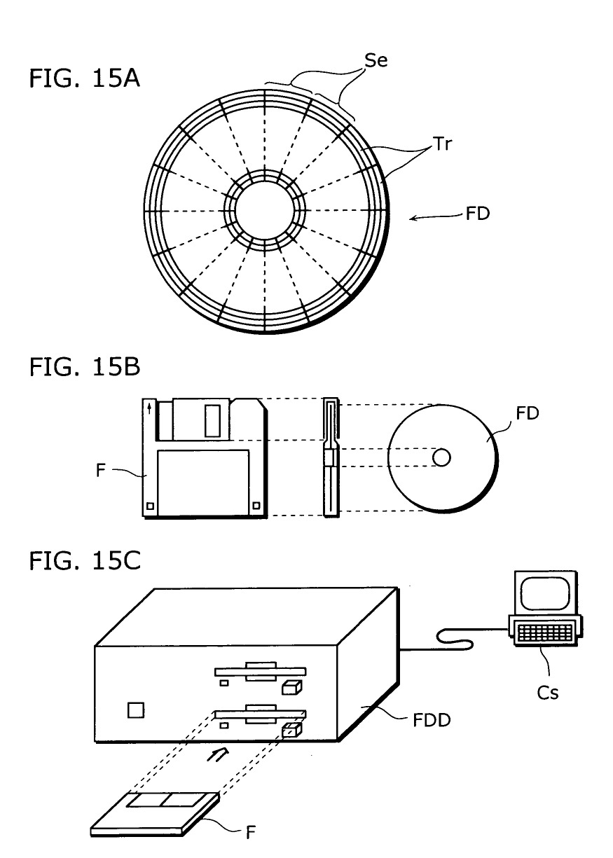

FIG. 15 is an explanatory diagram in which the moving picture coding method in the above embodiments is implemented with a computer system using a program recorded on a recording medium such as a flexible disc.

FIG. 15(b) shows a flexible disc seen from the front, as well as the flexible disc itself, FIG. 15(a) shows an example of a physical format for the flexible disc i.e. the recording medium. The flexible disc FD is embedded in a case F, and plural tracks TR are formed in a concentric shape from the outer ring to the inner ring on the surface of the disc; each track is divided into 16 sectors, Se, at different angles. Accordingly, the above program is recorded in regions assigned to the above flexible disc FD, on which the above program is stored.

FIG. 15(c) shows a structure for performing recording and reproduction of the above program onto the flexible disc FD. When recording the above program, which implements the moving picture coding method, onto the flexible disc FD, the above program is written from a computer system Cs through the flexible disc drive. Also, when building the above moving picture coding method, which implements the moving picture coding method using the program on the flexible disc, in a computer system, the program is read out of the flexible disc drive by the flexible disc and transferred to the computer system.

Note that in the above explanation, the moving picture coding device is explained using a flexible disc as a recording medium, however the moving picture coding device can be implemented using an optical disc as well. Also, the recording medium is not limited to the above explanation and can be implemented as an IC card, a ROM cassette and the like, and a program.

Note that the processes needed to implement the moving picture coding method shown in each of the above embodiments may be achieved in the form of an LSI. Each of these processes can be implemented in a plural single-function LSI.

The name used here is LSI, but it may also be called IC, system LSI, super LSI, or ultra LSI depending on the degree of integration.

Moreover, ways to achieve integration are not limited to the LSI, and special circuit or general purpose processors and so forth can also achieve the integration. A Field Programmable Gate Array (FPGA), which can be programmed after manufacturing LSI or a reconfigurable processor that allows re-configuration of the connection or configuration of circuit cells inside the LSI can be used for the same purpose.

In the future, with advancement in semiconductor technology, another derivative technology may replace LSI and the like. Of course, the integration may also be carried out by that technology.

Also, in the above embodiments, the telecine conversion device 200 is set on the outside of the moving picture coding device 100a, however the telecine conversion device 200 may be built into the moving picture coding device 100a.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The moving picture coding method according to the present invention is for example useful in application to a DVD device, a cellular phone, a personal computer and so on, and as a method for coding each picture which makes up a moving picture and generating a coded stream.

What is claimed is:

1. A moving picture coding method which codes a moving picture that includes a B picture on which predictive coding is performed by referencing plural coded pictures which are temporally located before or after the B picture, said moving picture coding method comprising:
predicting and generating a motion vector for a target block by referencing a motion vector of a coded picture that is temporally nearby, as a direct mode processing for the B picture; and
assessing whether use of the temporal direct mode should be disabled according to a condition for a moving picture to be coded,
wherein, in said assessing, predictive coding is performed on the moving picture to be coded using a process other than said predicting and generating, when use of the temporal direct mode is disabled.

2. The moving picture coding method according to claim 1,
wherein referencing a motion vector of a coded block located in a spatial periphery of the target block and predicting and generating a motion vector for the target block as a direct mode for the B picture is included in the process other than said predicting and generating, and
in said assessing, the predictive coding is performed on the moving picture to be coded using said predicting and generating when use of the temporal direct mode is disabled.

3. The moving picture coding method according to claim 1,
wherein in said assessing, it is assessed that use of the temporal direct mode should be disabled when it is assessed that the time intervals of pictures which compose the moving picture to be coded are not fixed.

4. The moving picture coding method according to claim 1,
wherein in said assessing, it is assessed that use of the temporal direct mode should be disabled when it is assessed that a picture-display time interval conversion has been performed on the moving picture to be coded.

5. The moving picture coding method according to claim 1,
wherein in said assessing, it is assessed that use of the temporal direct mode should be disabled when it is assessed that the coded picture used as a reference for the motion vector in the temporal direct mode is an I picture on which intra-picture predictive coding is to be performed.

6. The moving picture coding method according to claim 1,
wherein in said assessing, it is assessed whether or not one of at least two of the following cases applies:
when it is assessed that the time intervals for the pictures which compose the moving picture to be coded are not fixed;
when it is assessed that a picture-display time interval conversion has been performed on the moving picture to be coded; and
when it is assessed that the coded picture that is used as a reference for the motion vector in the temporal direct mode is an I picture on which intra-picture predictive coding is performed, and
in the case where one of at least two of the cases applies, it is assessed that use of the temporal direct mode should be disabled.

7. A moving picture coding device which codes a moving picture that includes a B picture on which predictive coding is performed by referencing plural coded pictures which are temporally located before or after the B picture, said moving picture coding device comprising:
a temporal direct mode processing unit operable to predict and generate a motion vector for a target block by referencing a motion vector of a coded picture that is temporally nearby, as a direct mode processing for the B picture; and
a temporal direct mode disabling assessment unit operable to assess whether use of the temporal direct mode should be disabled according to a condition for the moving picture to be coded,
wherein, in said temporal direct mode assessment unit, predictive coding is performed on the moving picture to be coded using a unit other than said temporal direct mode processing unit, when use of the temporal direct mode is disabled.

8. A program for a moving picture coding method which codes a moving picture that includes a B picture on which predictive coding is performed by referencing plural coded pictures which are temporally located before or after the B picture, said program being stored on a computer-readable medium and causing a computer to execute:
predicting and generating a motion vector for a target block by referencing a motion vector of a coded picture that is temporally nearby, as a direct mode processing for the B picture; and
assessing whether use of the temporal direct mode should be disabled according to a condition for the moving picture to be coded,
wherein, in said assessing, predictive coding is performed on the moving picture to be coded using a process other than said predicting and generating, when use of the temporal direct mode is disabled.

9. An integrated circuit in which the units, which are included in a moving picture coding device which codes a moving picture that includes a B picture on which predictive coding is performed by referencing plural coded pictures which are temporally located before or after the B picture, are integrated, the units being:
a temporal direct mode processing unit operable to predict and generate a motion vector for a target block by referencing a motion vector of a coded picture that is temporally near, as a direct mode processing for the B picture; and
a temporal direct mode disabling assessment unit operable to assess whether use of the temporal direct mode should be disabled according to a condition for the moving picture to be coded,
wherein, in said temporal direct mode assessment unit, predictive coding is performed on the moving picture to be coded using a unit other than said temporal direct mode processing unit, when use of the temporal direct mode is disabled.
